(19) United States
(12) Patent Application Publication
(10) Pub. No.: US 2013/0215708 A1
(43) Pub. Date: Aug. 22, 2013

(54) Mixing Devices

(71) Applicant: Stephen Davis, East Victoria Park WA (AU)

(72) Inventor: Stephen Davis, East Victoria Park WA (AU)

(21) Appl. No.: 13/880,050

(22) PCT Filed: Oct. 18, 2011
(86) PCT No.: PCT/AU11/01330

§ 371 Date: Apr. 17, 2013

(30) Foreign Application Priority Data
Oct. 18, 2010 (AU) 2010904633
Oct. 18, 2010 (AU) 2010904636

(51) Int. Cl. B01F 7/02; A47G 23/00

(52) U.S. Cl. CPC B01F 7/021; A47G 23/00
USPC 366/331; 220/574

(57) ABSTRACT

In one preferred form of the present invention, there is provided a mixing device (10) comprising a bowl structure (12) for receiving material. A connector (14) is provided for allowing a motor (16) to turn a mixing implement (18) within the bowl structure (12). The connector (14) is arranged to allow the mixing implement (18) to move by rotating away from the central axis (24) of the bowl structure (12) in a desirable manner.

### FIELD OF THE INVENTION

The present invention relates to mixing devices. In one preferred form the present invention relates to kitchen appliances and methods.

### BACKGROUND To THE INVENTION

Stand kitchen appliance mixers typically comprise a bowl that is held by two arms or which, alternatively, rests on top of a base.

U.S. Pat. No. 5,758,963 to Premark FEG LLC filed 12 Nov. 1996 discloses such a commercial mixer. As shown in FIG. 1a of the drawings attached hereto, the mixer 10 of U.S. Pat. No. 5,758,963 includes a stand 14 and a body 12 where the body 12 holds and extends over a bowl 26. The bowl 26 is supported by two arms 24 using which the bowl 26 can be raised and lowered to provide access to a mixing hook 50.

Smaller mixers for domestic applications are also available and are generally of the same configuration but with a fixed base and with the motor pivotally connected to the stand. Known domestic mixers include the KitchenAid Artisan and the Kenwood Chef.

Industrial mixers are used in a variety of applications including the mixing of concrete.

The inventor has invented a kitchen mixing device which the inventor considers may have industrial applications including building and possibly mining applications.

It is against this background and the problems and difficulties associated therewith that the present invention has been developed.

### SUMMARY OF THE INVENTION

According to a first aspect of preferred embodiments herein described there is provided a mixing device comprising: a bowl structure for receiving material; and a connector for allowing a motor to turn a mixing implement within the bowl structure wherein the connector is arranged to allow the mixing implement to move by rotating away from the central axis of the bowl structure in a desirable manner.

Preferably the mixing device comprises an kitchen appliance, the material comprises foodstuff, the mixing implement comprises a food stuff preparation implement and the bowl structure comprises a bowl.

Preferably the connecter is arranged to allow the mixing implement to automatically move such that the mixing implement naturally circulates in a desirable manner when being turned in the bowl structure by the motor.

Preferably the bowl structure has substantially hemispherical inner mixing surface arranged to allow the mixing implement to be rotated by at least 10 degrees away from the central axis of the bowl structure.

Preferably the connector includes at least two location members for centrally locating the connector relative to the central axis of the bowl structure.

Preferably each of the location members is adapted to resist vertical rotation and resiliently bias the connector towards a horizontally aligned condition in which the mixing implement is aligned with the central axis of the bowl structure.

According to another aspect of preferred embodiments herein described there is provided a mixing device comprising: a bowl structure for receiving material and a support structure for supporting the bowl structure above a surface, the support structure comprising at least three leg portions, each leg portion having a surface support portion and fastening portion wherein when the at least three leg portions support the bowl structure the surface support portions are spaced outside the bounds of the fastening portion such that loading the bowl structure with material causes the fastening portions to be biased inwardly towards the central axis of the bowl structure and the surface support engagement portions to be biased outwardly away from the central axis of the bowl structure.

Preferably biasing of the surface support portions outwardly away from the central axis of the bowl structure serves to assist with supporting the bowl structure.

According to another aspect of preferred embodiments herein described there is provided a mixing device comprising: a bowl structure for receiving material and a connector wherein the connector comprises at least two elements for suspending a motor above the bowl structure, the elements being adapted to extend from spaced apart locations located adjacent the periphery of the bowl structure to the motor so as to suspend the motor above the bowl structure in position.

Preferably the connector is adapted to allow the motor to rotate away from the central axis of the bowl structure. Such that when a mixing implement is connected to the motor, the mixing implement is able to rotate in a desirable manner.

According to another aspect of preferred embodiments herein described there is provided a mixing device comprising: a bowl structure for receiving material; a connector for supporting a motor above the bowl structure and a support structure for supporting the bowl structure above a surface wherein the support structure comprises at least three support members each having a portion for bearing against the ground, a portion for supporting the bowl structure and a coupling portion for being connected to a respective nearby one of the other support members.

Preferably the mixing device includes plurality of collars for sliding over the coupling portions of the support members to connect the support members together.

According to another aspect of preferred embodiments herein described there is provided a mixing device method: comprising providing a mixing device by providing a bowl structure having at least a substantially hemispherical base portion, using at least three support members to support the bowl structure and then holding the support members together using a connector for supporting motor above the bowl structure.

Preferably biasing of the surface support portions outwardly away from the central axis of the bowl structure serves to assist with supporting the bowl structure.

According to another aspect of preferred embodiments herein described there is provided a mixing device comprising: a bowl structure for receiving material; and a connector for allowing a motor to turn a mixing implement within the bowl structure wherein the connector is arranged to allow the mixing implement to naturally circulate in a desirable manner when being turned in the bowl structure by the motor.

As will be discussed there are considered to be a number of preferred arrangements of the present invention that provide several advantages including:
(i) Kitchen appliances and methods that can be used for kneading dough, blending fluids, whipping eggs and general mixing in which there is provided a natural tendency for the kitchen appliance implement to provide a circular action that rides up the sides of the bowl in an inclined matter.
(ii) Kitchen appliances and methods allowing for advantageous tipping of the bowl to allow removal of processed food stuffs and for the bowl to receive further foods stuffs for subsequent processing.
(iii) Kitchen appliances and methods in which there are provided an advantageously reduced number of components that can be readily assembled and disassembled and which allow for convenient storage
(iv) Kitchen appliances and methods providing mixers with say 5 to 60 plus litre capacities where the mixers have advantageous stability characteristics without necessarily having to provide a conventional bowl holding stands possibly weighing several kilograms or, in the case of commercial mixers several tens of kilograms.
(v) Kitchen appliances and methods providing mixers in which the manufacture thereof advantageously is considered to involve much less welding and machining
(vi) Kitchen appliances and methods providing mixers where motors can be readily maintained and replaced.
(vii) Kitchen appliances and methods in which the full motor and motor housing can be switched for different food processing applications.
(viii) Kitchen appliances and methods where mixers are provided that are considered to be much more effective in terms of their manufacturing cost and overall weight in comparison to their mixing capacity.

It is to be recognised that other aspects, preferred forms and advantages of the present invention will be apparent from the present specification including the detailed description, drawings and claims.

### BRIEF DESCRIPTION OF DRAWINGS

In order to facilitate a better understanding of the present invention, several preferred embodiments will now be described with reference to the accompanying drawings, in which:

FIG. 1a provides a perspective view of a mixer according to U.S. Pat. No. 5,758,963;

FIG. 1b provides a perspective view of a mixer according to U.S. Pat. No. 5,492,401;

FIG. 2 provides a perspective view of a mixer according to a first preferred embodiment of the present invention;

FIG. 3 provides a schematic view showing rotation of a mixing implement forming part of the mixer shown in FIG. 1;

FIG. 4 provides a perspective view of a connector forming part of the mixer shown in FIG. 1;

FIG. 5 provides a perspective view of showing how the connector shown in FIG. 4 supports a motor;

FIG. 6 provides a perspective view of an alternate component relating to the connector shown in FIG. 4;

FIG. 7 provides a further perspective view of the mixer shown in FIG. 1;

FIG. 8 provides a similar schematic view to that of FIG. 3 also of the mixer shown in FIG. 1;

FIGS. 9 and 10 illustrate an advantageous use of the mixer shown in FIG. 1;

FIG. 11 provides several perspective views relating to a support structure forming part of the mixer shown in FIG. 1;

FIG. 12 shows a method according to a second preferred embodiment of the present invention;

FIGS. 13 and 14 show a mixer according to a third preferred embodiment of the preset invention;

FIG. 15 provides a schematic view of an alternate support structure in yet further embodiment of the present invention;

FIGS. 16a to 16c provide several views of a mixer according to yet another preferred embodiment of the present invention;

FIG. 17 provides a perspective view of a portion of the mixer shown in FIGS. 16a to 16c;

FIG. 18 provides another view of the mixer shown in FIGS. 16a to 16c; and

FIGS. 19a to 19c provides several views of a mixer according to another preferred embodiment.

### DETAILED DESCRIPTION OF THE EMBODIMENTS

It is to be appreciated that each of the embodiments is specifically described and that the present invention is not to be construed as being limited to any specific feature or element of any one of the embodiments. Neither is the present invention to be construed as being limited to any feature of a number of the embodiments or variations described in relation to the embodiments.

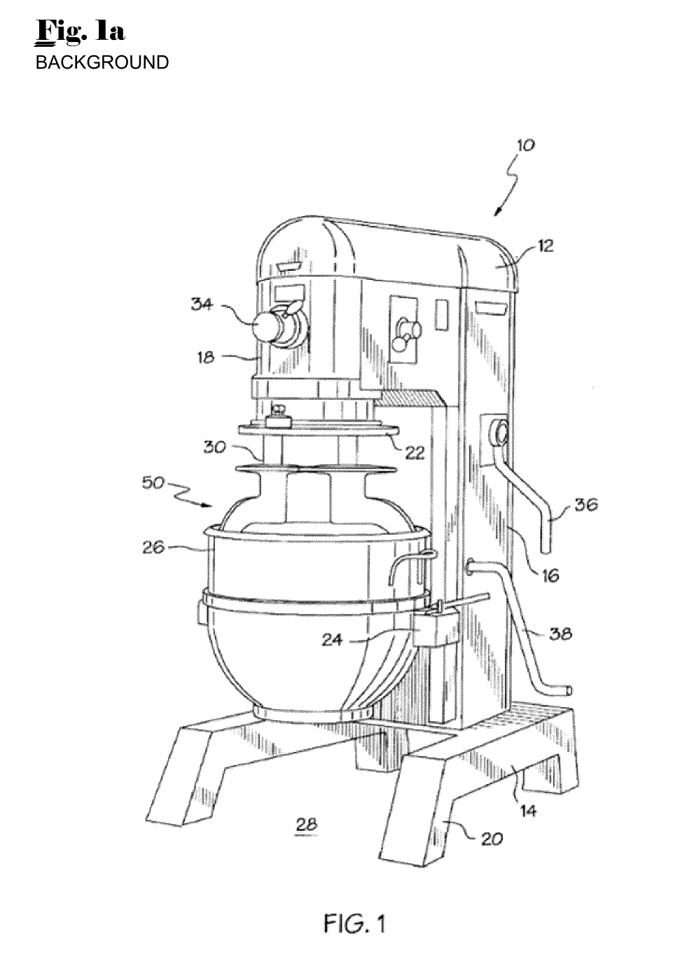

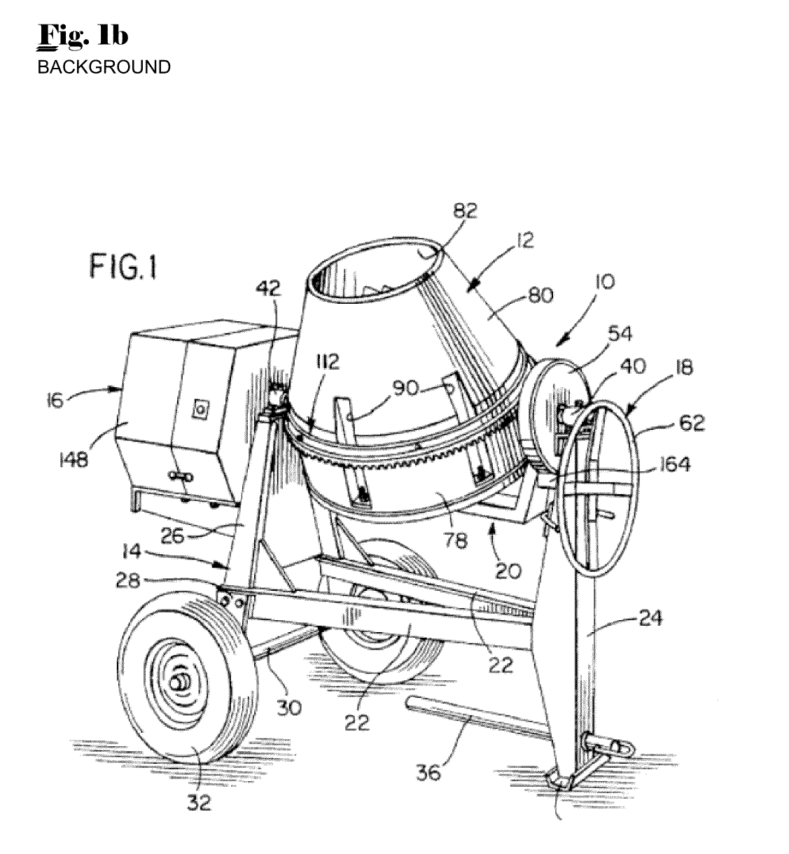

Referring to FIG. 1a there is shown a commercial bread mixer. Whilst the present invention has particular application to bread mixers and kitchen appliances the applicant considers that the invention may also have other applications. For example the present invention may be find application as a concrete mixer. Referring to FIG. 1b there is shown a concrete mixer disclosed in U.S. Pat. No. 5,492,401 to David W. Halsted filed 26 Jul. 1994. The mixer includes a number of components including a plastic mixing drum.

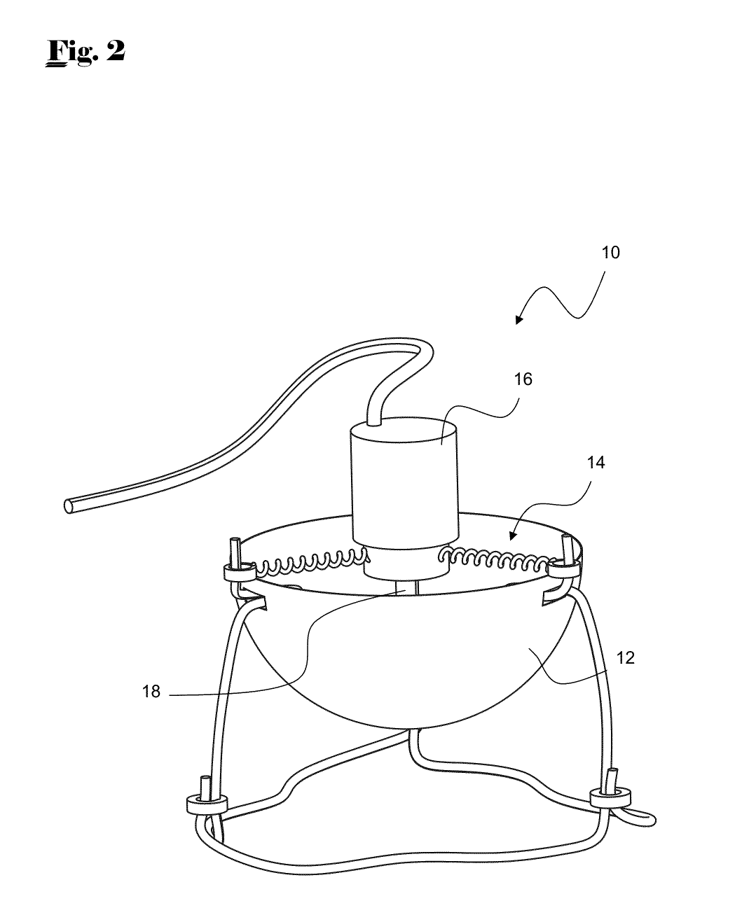

Referring to FIG. 2, there is shown a kitchen appliance in the form of a mixer 10 according to a first preferred embodiment of the present invention. The applicant considers that the present embodiment has been invented as a kitchen mixer concept in competition with conventional kitchen mixers.

In terms of the concept, the mixer 10 is considered to advantageously provide a natural tendency to circulate when mixing, where the tendency advantageously serves to assist in the mixing process. The mixer 10 is also considered to be advantageously light, stable, readily manufactured and readily repaired. Notably the form of mixer 10 is considered to have applications in both the commercial and the domestic mixer markets.

As shown in FIG. 2 the mixer 10 comprises a bowl structure 12 in the form of a bowl for receiving foodstuffs. A connector 14 is provided to allowing a motor 16 to turn a food stuff preparation implement 18 within the bowl 12. The connector 14 is advantageously arranged to allow the food stuff preparation implement 18 to move by rotating in a desirable manner relative to the bowl 12. The food stuff preparation implement 18 and other components of the mixer 10 are more clearly shown in FIG. 5.

In the embodiment, the connector 14 allows the food stuff preparation implement 18 to move by rotation in all vertical planes by a person pulling or pushing on the motor 16. In addition to the option of manual rotation, the connector 14 is arranged to allow the food stuff preparation implement 18 to automatically progress such that the food stuff preparation implement 18 naturally circulates in a desirable manner when being turned in the bowl 12 by the motor 16. The circular action resembles a circular inclined progression about the surface of the bowl 12 with vibration from the motor 16 providing a degree of wobble. In this regard it is to be appreciated that the circular action comprises the food implement 18 rotating about an axis substantially perpendicular to the central axis of the bowl 12 (ie in a horizontal plane). As will be described the circular action depends on the density and amount of material being mixed. Generally, the heavier the material the more pronounced the circular inclined action.

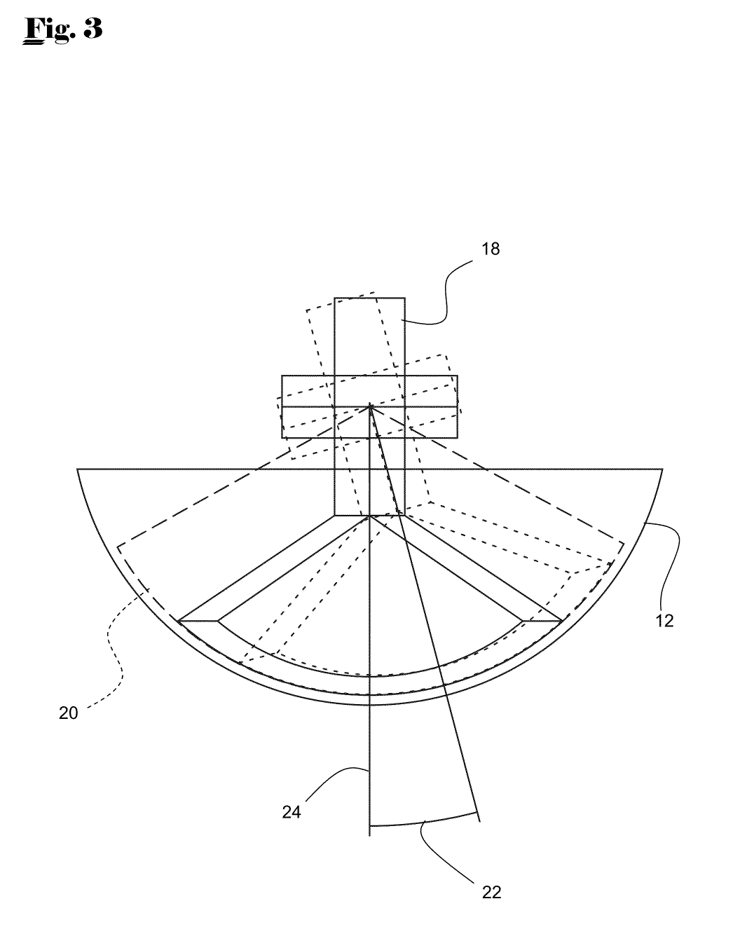

As shown in FIG. 3, the bowl 12 has a substantially hemispherical inner mixing surface 20 arranged to allow the food stuff preparation implement 18 to be rotated vertically by an angle 22 of about 15 degrees in all radial directions away from the central axis 24 of the bowl 12. Depending on the application other angles such as 20, 30, 40, 50+ degrees are possible. With respect to the natural circular action the inventor considers that a rotation of say 5 to 10 degrees during the action will produce an advantageous mixing action and allow relatively large volumes of material to be mixed.

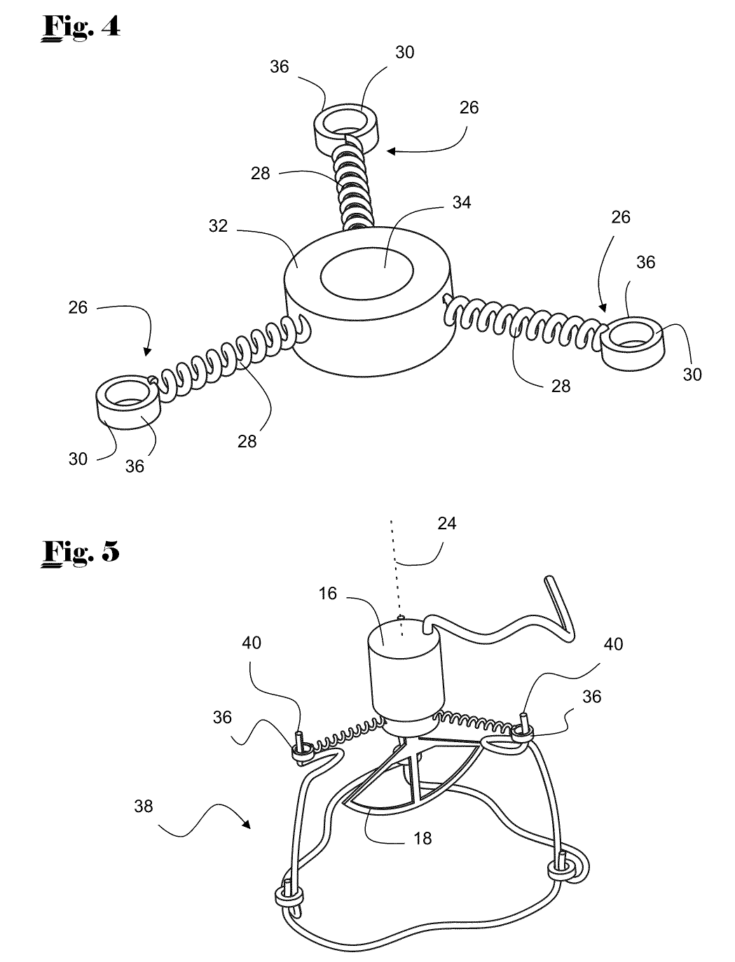

As shown in FIG. 4 the connector 14 comprises three location members 26 in the form of springs 28 having end connectors 30. The location members 26 are connected to a centrally located mount 32 that is adapted have the motor 16 secured thereto. In one arrangement the motor 16 includes a male threaded end that is adapted to engage a corresponding threaded portion in a central opening 34 of the mount 32. In other embodiments, the mount 32 comprises a collar of adjustable size adapted releasably hold the motor 16. In yet further embodiments the mount 32 is integral with the motor 16. The provisions of the springs 28 is considered to be advantageous as the springs 28 serve to limit vibration, have advantageous wear characteristics and smoothly absorb torque from the motor 16.

As shown in FIGS. 4 and 5, the end connectors 30 comprise circular rings 36 that adapted to be pulled over a support structure 38 that serves to support the bowl 12 as illustrated in FIG. 1. The circular rings 36 are adapted to receive upstanding end member portions 40 of the support structure 38 near the periphery of the bowl 12.

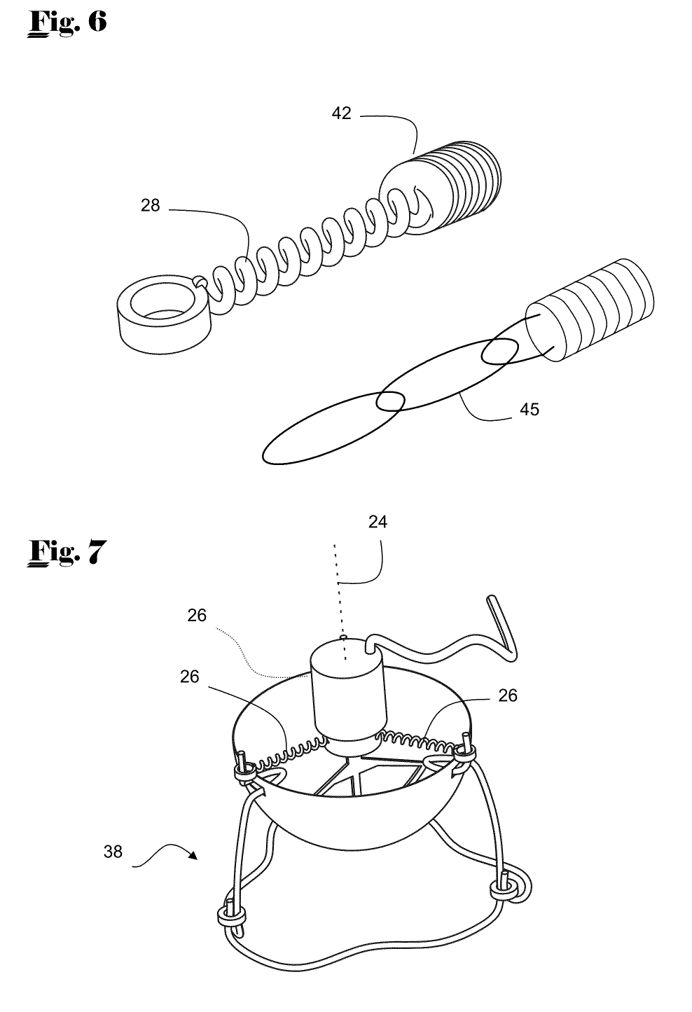

In this embodiment the firmness of the springs 28 is advantageously selected so as to be able to both support the weight of the motor 16 as well as provide the advantageous natural circular inclined motion of the mixer 10 to assist with mixing. The applicant is presently considering whether connectors of different stiffness, size and/or other characteristics should be provided with the mixer 10. As shown in FIG. 6, advantageous arrangements are envisaged in which the springs 28 are connected to fasteners 42 that allow the springs to be removably attachable to the mount 32. The inventor is also considering embodiments in which the location members 26 comprise a number of rings 45 that allow for a degree of movement. The provisions of the springs 28 is however considered to be preferable to the rings as the springs 28 gently absorb the torque of the motor 16, gently distribute forces to the support structure 38, limit vibration and equally balance the mount 32 without flopping. The springs 28 also, hold the motor 16 upright and allow for gentle motion.

As shown in FIG. 7, the three location members 26 serve to centrally locate the connector 14 relative to the central axis 24 of the bowl 12 and the support structure 38. This serves to advantageously position the food stuff preparation implement 18 in a first position that is centrally disposed such that the longitudinal axis of the food stuff preparation implement 18 is aligned with the central axis 24 of the bowl 12 as shown in FIG. 7.

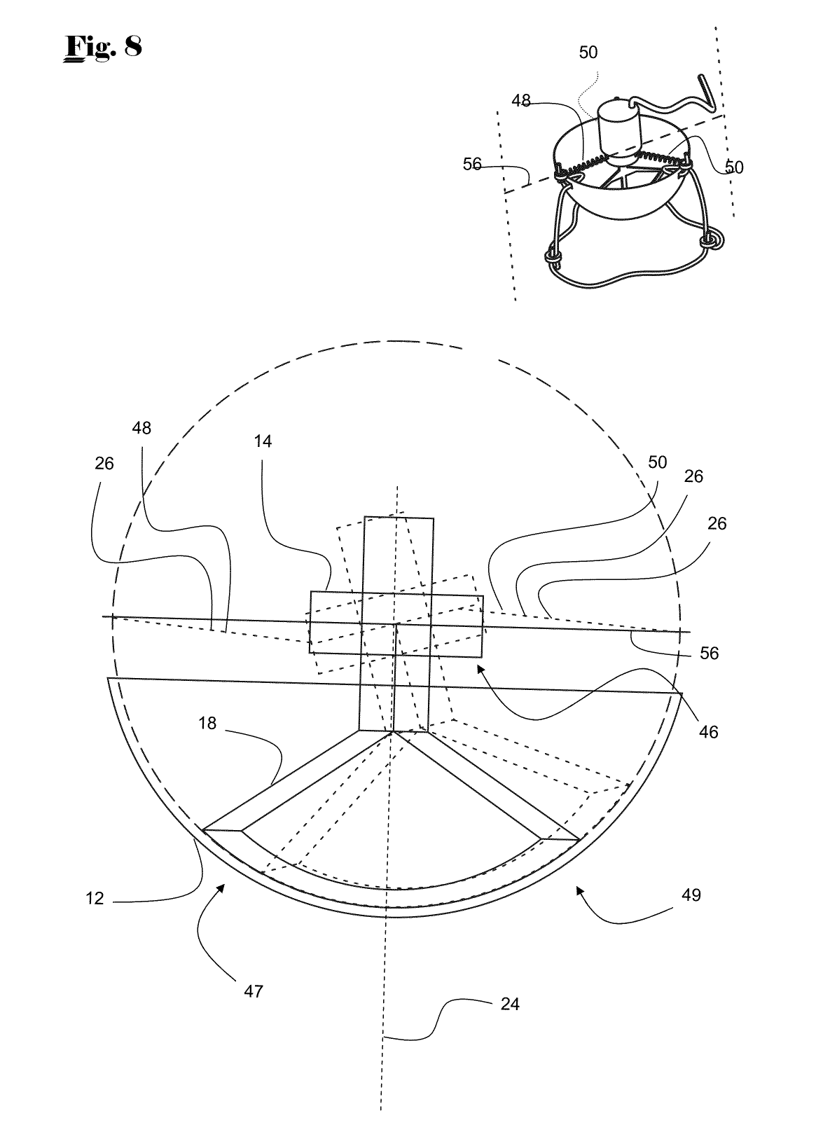

As shown in FIG. 8, the location members 26 are adapted to resist vertical rotation of the motor 16 and food stuff preparation implement 18, and resiliently bias the connector 14 towards a horizontally aligned condition 46 in which the food stuff preparation implement 18 is aligned with the central axis 24 of the bowl 12. As the motor 16 is rotated to the left hand side 47 the working part of the food stuff preparation implement 18 moves more to the right hand side 49. A first one 48 of the location members 26 is forced to move downwardly whilst the other two location members 50 move upwardly to form a parallelogram type shape that exerts a correcting torque serving to bias the connector 14 and the food stuff preparation implement 18 towards the horizontally aligned condition 46. As would be apparent the ability of the food stuff processing implement 18 to be rotated in all the vertical planes, i.e. in all radial directions relative to the central axis 24 (ie about axes lying in horizontal planes), is advantageous as the user can move the food stuff preparation implement 18 to the right hand side 49 whilst scraping food stuff on the left hand side 47 (relative to the cross section shown) and then return the food stuff preparation implement 18 back to its original condition all whilst the food stuff preparation implement 18 is being turned by the motor 16. As would be apparent, by moving the motor 16, the food stuff preparation implement 18 need not be touched with a spatula or otherwise as the sides of the bowl 12 are being scraped down. With the bowl 12 being advantageously hemispherical, the food stuff preparation implement 18 is able to follow the contour of the bowl 12 and maintains a desirable spacing therewith. The food stuff preparation implement 18 can be used to scrape a substantial portion of the surface of the bowl 12. The food stuff preparation implement 18 accordingly operates over a surface that is much larger in size than the mixing implement would otherwise be able to due to the angle of rotation away from the central axis 24.

In this embodiment the centre of mass of the motor 16 is spaced above the pivoting connector 14. The inventor is presently determining advantageous positioning of the motor 16 such that the centre of mass of the motor is spaced either above, inline or below the connector 14. Furthermore, in this embodiment, the connector 14 is located inline with the hemispherical equator of the bowl structure 12. This is generally preferred however it is to be appreciated that the springs 26 do advantageous provide some flexibility.

As indicated above, it is considered to be particularly advantageous that that the mixing implement 18 will provide a desirable circular/whirling action with some wobble due to vibration without any human interaction. The natural circular tendency is considered to arrive because the mixing action of the material will produce an off-centre force that is transferred to the connector 14. Consequently the connector provides the mixing implement 18 with an advantageous circular action wherein each location member 26 naturally progresses above and below the horizontal line 56 shown in FIG. 8.

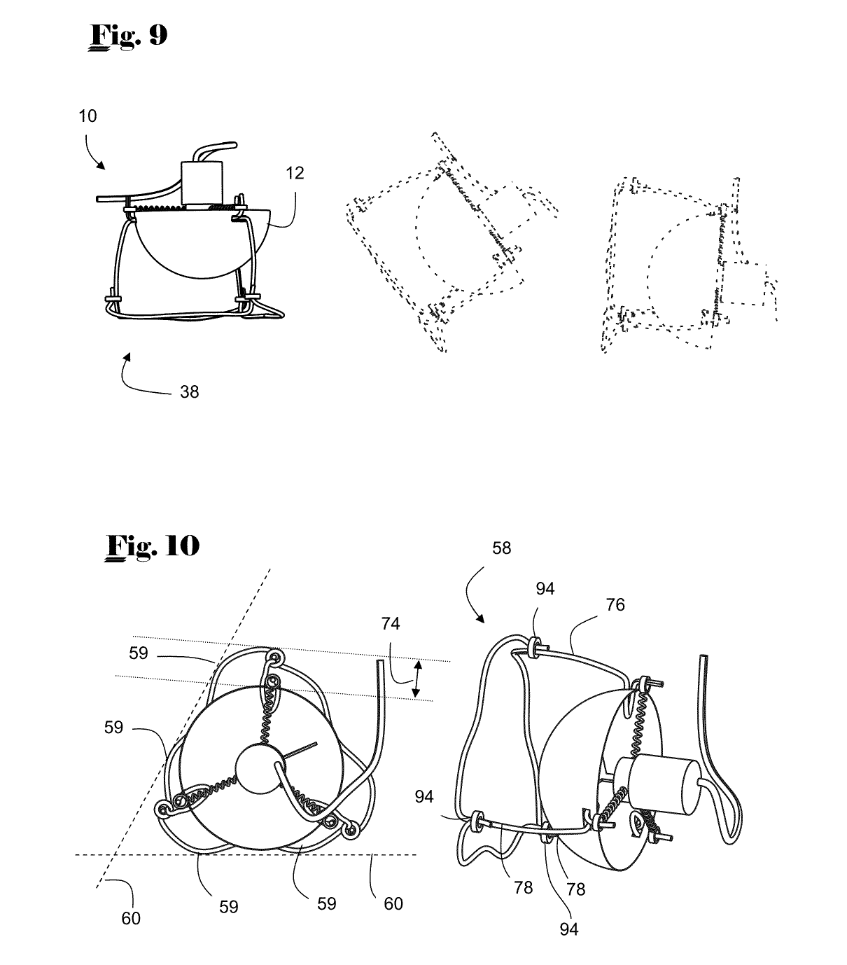

The form of the support structure 38 is considered to be advantageous as it holds the bowl structure 12 in a relative fixed relationship allowing for tipping of the mixer 10 together with the bowl structure 12. As shown in FIG. 9 the mixer 10 can be readily tipped from 0 to 45 to 60 and then over 90 degrees to allow the contents of the bowl structure 12 to be readily removed.

As shown in FIG. 10 the support structure provides a base 58 which in this embodiment is triangular. Moreover the sides of the base each have portions 59 that extend beyond the periphery of the bowl structure 12 that allow for advantageous tipping. This is illustrated by the lines 60 shown in FIG. 10.

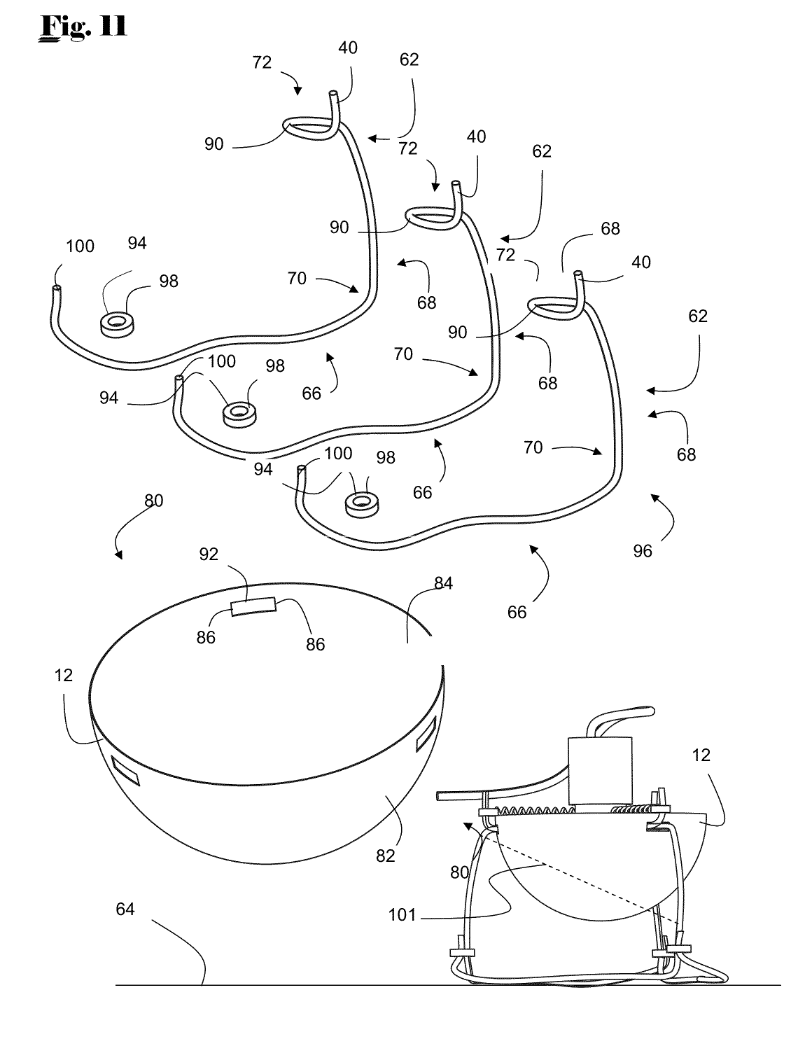

As shown in FIG. 11 the support structure 38 comprises three leg portions 62 that support the bowl 12 above a surface 64 provided by a benchtop. Each leg portion 62 includes a base portion 66 for bearing against the surface 64 and an extension portion 68 for holding the bowl 12 in position. Each extension portion 68 includes a support portion 70 and a fastening portion 72.

The base portions 66 extend beyond the periphery of the bowl 12 for advantageous tipping as discussed in relation to FIG. 10. The support portions 70 are spaced outside the bounds of the bowl 12 by an amount 74 shown in FIG. 10. Advantageously, this causes the fastening portions 72 to be biased inwardly towards the central axis 24 of the bowl 12 when loading the bowl 12 with food stuff. In addition this causes the support portions 70 to be biased outwardly away from the central axis 24 of the bowl 12. This is considered to be particularly advantageous as heavy cast stands of metal are not required to support the bowl 12 and the present embodiment is considered to be advantageous for this reason. As would be apparent, the leg portions 62 advantageously splay outwards which serves to provide further support.

To tip the mixer 10, a first one 76 of the leg potions 62 is raised with respect to the other two leg portions 78, as shown in FIG. 10, which support the bowl 12 above surface 64. More particularly, the other two leg portions 78 advantageously serve to hold the bowl 12 in the tipped condition and prevent rotation of the bowl 12 about the central axis 24 of the bowl 12.

As shown in FIG. 11, the bowl 12 includes openings 80 for receiving the fastening portions 72. In this embodiment the openings 80 extend through the surface of the bowl 12 from the exterior surface 82 to the hemispherical inner surface 84. The openings 80 are rectangular having lateral side portions 86 for bearing against the sides 88 of the fastening portions 72. Upper surfaces 90 of the fastening portions 72 bear against the length 92 of each respective opening 80.

Each of the leg portions 62 includes a coupling portion 94 at their lower ends 96 for being connected to a respective nearby one of the other leg portions 62. The coupling portions 94 advantageously comprise collar portions 98 that are adapted to slide along the extension portions 68 and receive upstanding ends 100 of the base portions 66 to connect the leg portions 62 together to form the support structure 38.

Each of the upstanding end member portions 40 of the fastening portions 72 (see FIG. 5) is received by a respective circular ring 36 of the connector 14 as discussed. This is considered to be advantageous because the connector 14 itself serves to hold the leg portions 62 in position. The inventor is presently investigating whether a reinforcing arm 101 is required in embodiments supporting mixing weights of say 60 kg.

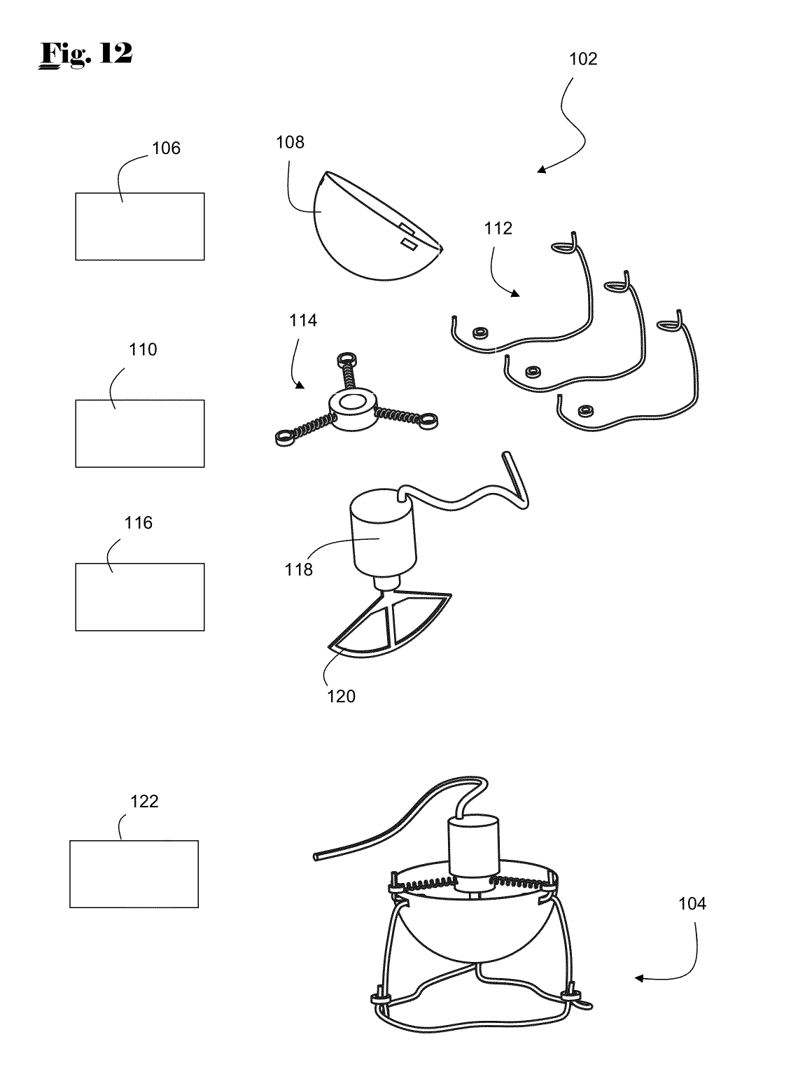

In the present embodiment, assembly and disassembly can be advantageously performed in a matter one or two minutes by moving the collar portions 98 upwards to disassemble the support structure 38, then removing the connector 14. This is illustrated by the method 102 shown in FIG. 12. The method 102 advantageous provides a mixer 104.

At block 106 the method includes providing a bowl 108 that is a substantially hemispherical. At block 110 at three support members 112 are used to support the bowl 108 and a connector 114 is used to hold the support members 112 together. At block 116 an electric motor 118 is suspended above the bowl 108 using the connector 114 and connecting a correspondingly shaped hemispherical shaped food stuff preparation implement 120 to the motor 118 such that the implement 120 extends downwardly into the bowl 108.

At block 122 the method 102 includes using the mixer 104 to prepare food with mixer 104 automatically providing a desirable wobbling action serving to assist with the preparation of food stuff within the bowl.

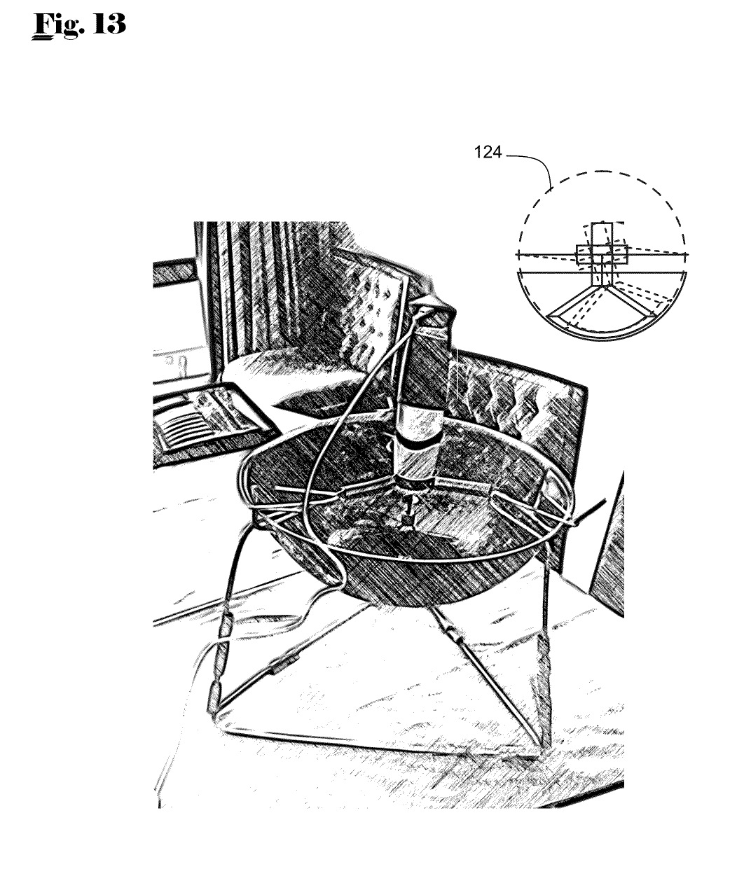

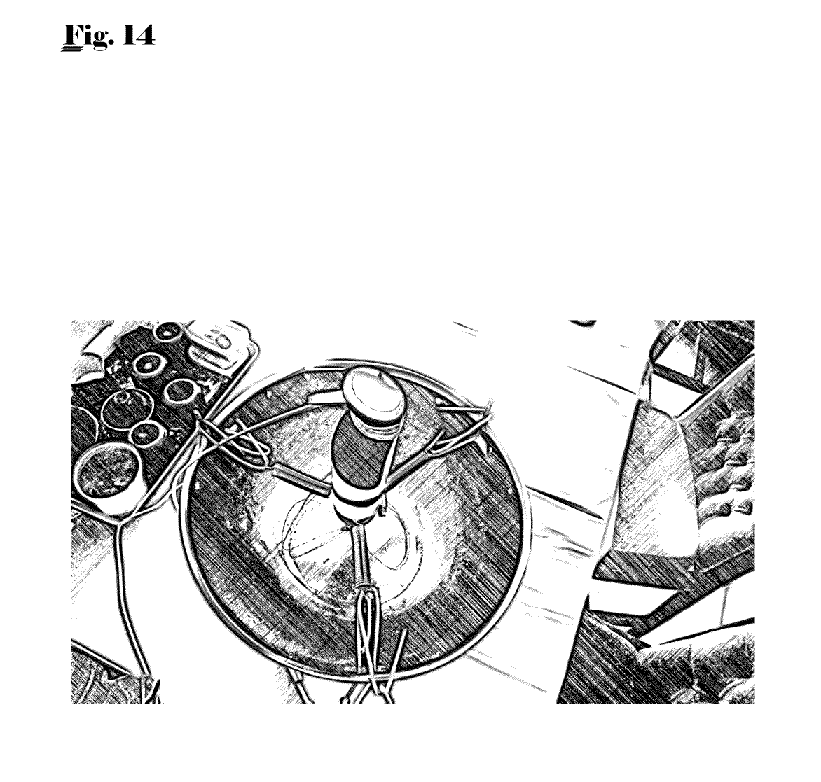

FIGS. 13 and 14 illustrate a first prototype of a kitchen mixer constructed by the present inventor. In the of the kitchen mixer, the prototype can be assembled and disabled in about 60 seconds and be packed away for ready storage. This is considered to be advantageous in comparison to conventional stand mixers. Notably neither the base of the bowl nor the preparation implement has a hemispherical profile. Rather the implement is adapted to conform to the base of the bowl by being of a flexible construction. A hemispherical arrangement such as those shown in outline 124 is considered advantageous and in particular, for preparing dough. FIG. 14 illustrates another preferred arrangement in the form of a stand 126 for supporting the bowl shown in FIGS. 13 and 14. In comparison to convention planetary mixer stands the stand is considered to be advantageously as it required what is considered to be much less welding and machining Together, the components of the form of the bowl, the connector and the motor (along with the food preparation implement), the stand can be used to say provide a 60/100 litre kitchen mixer of advantageous weight and cost in comparison to convention mixers together with the advantageous mixing action discussed. With kitchen and industrial mixers various sizes of mixer are of course possible. For example a 2 to 100+ litre mixer may be provided.

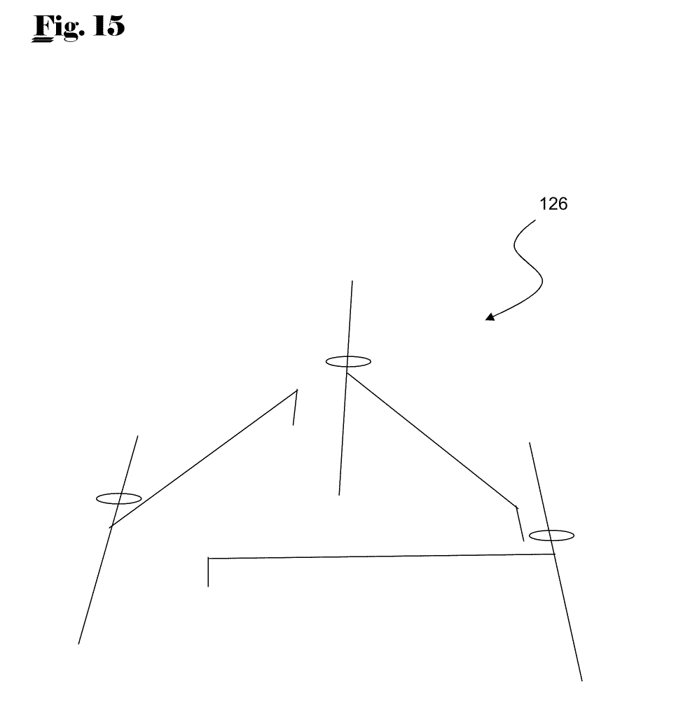

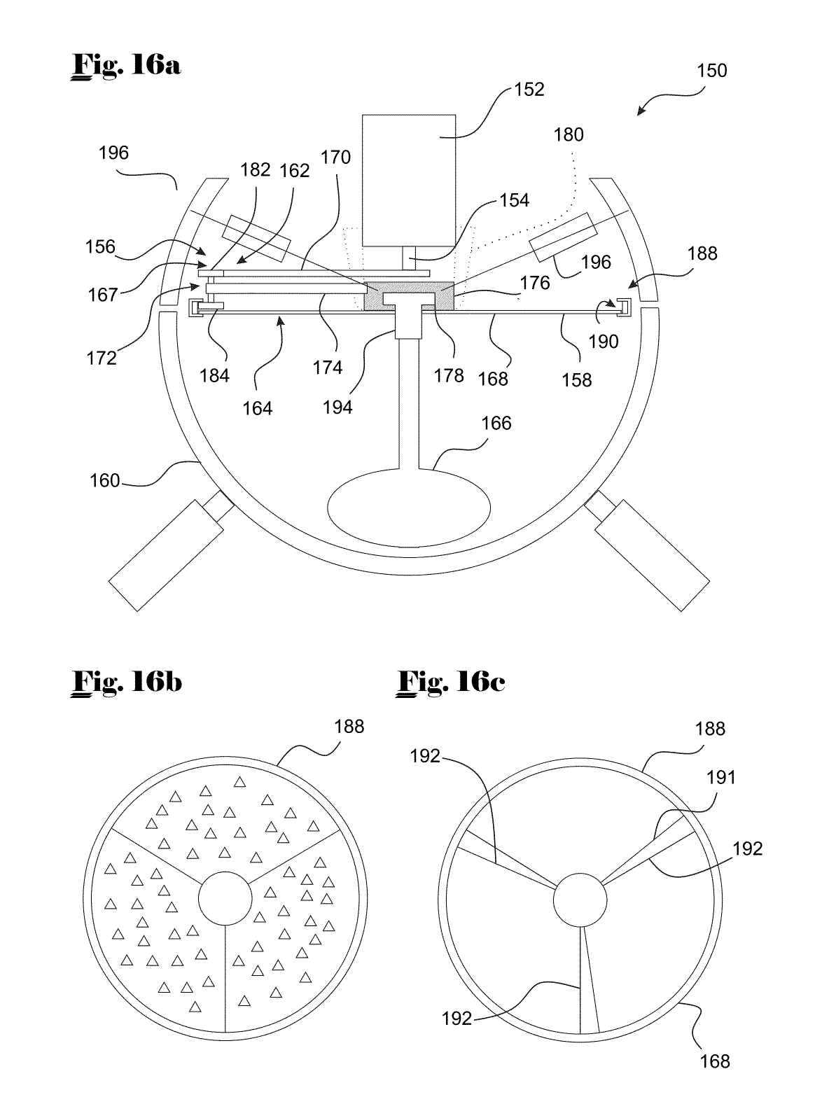

Referring to FIGS. 16a and 16b there is shown a mixer 150 according to further preferred embodiment of the present invention. The mixer 150 includes a motor 152 having a shaft 154. A gearing arrangement 156 is advantageously provided to reduce a relatively high rotational speed from the motor 152.

The gearing arrangement 156 includes a relatively large gear 158. The gear 158 extends a substantial distance away from the shaft 154 of the motor 152. In this case the diameter of the gear 158 is about 90% of the diameter of the bowl 160 of the mixer 150. This advantageously provides a rotational speed reduction from about 1400 rpm to about 20 rpm.

The gearing arrangement 156 includes a first gear extension 162 that extends from the motor 152 a substantial distance towards the periphery of the bowl 160. A second gear extension 164 extends from adjacent the periphery of the bowl 160 towards the top of a food preparation implement 166. The first gear extension 162 provides a belt drive 167 and the second gear extension 164 provides a support element in the form of a rotational food cutting disc 168. The food cutting disc 168 is disposed in the vicinity of the top of the bowl 160 of the mixing device 150. In another embodiment the food cutting disc comprises a number of elongate support arms to which different blades can be attached.

As the shaft 154 of the motor 152 rotates, the shaft 154 moves a belt 170. The belt 170 in turn rotates a cog arrangement 172 that rotates the relatively large gear 158. The cog arrangement 172 is supported by a support 174 that extends from a mount 176. The mount 176 includes a first attachment 178 for holding the food preparation implement 166. The mount 176 further includes a second attachment 180 in the form of a number of arms for supporting the motor 152. The belt 170 and cog arrangement 172 in combination with the cutting disc 168 serve to transmit rotational torque from the shaft 154 of the motor 152 to the food preparation implement 166.

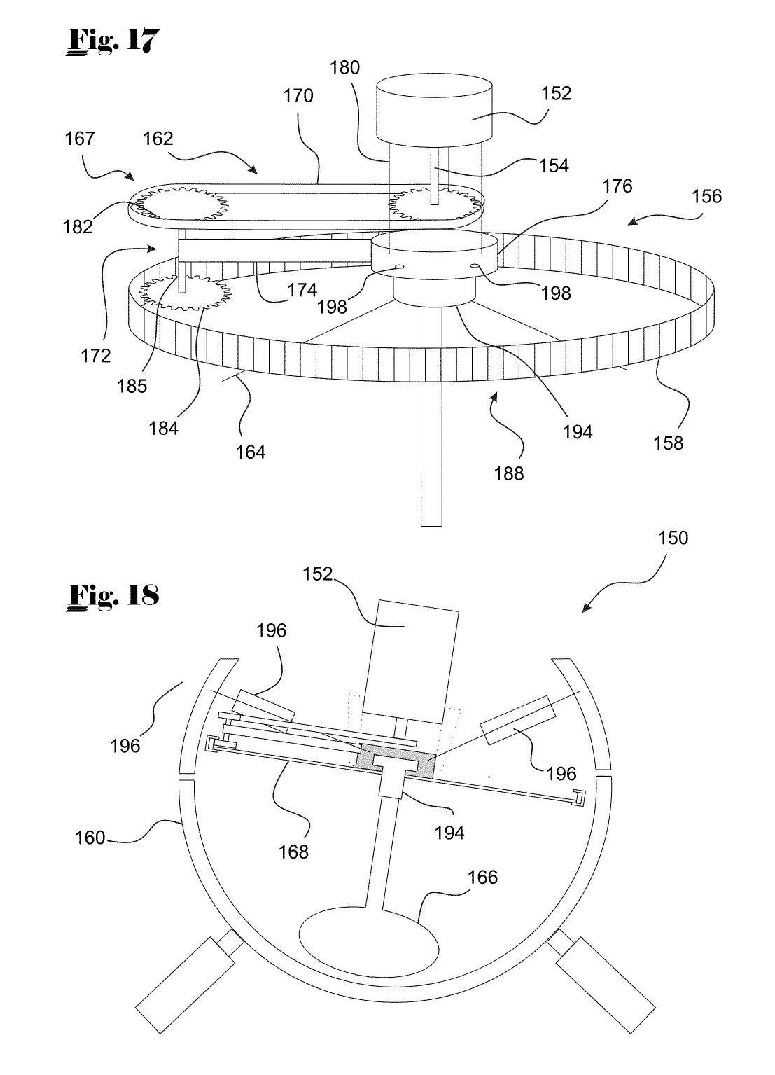

FIG. 17 illustrates the support 174 that extends from the mount 176 to support the cog arrangement 172. The cog arrangement 172 includes an upper cog 182 and a lower cog 184 connected by a shaft 185 that spins in a bearing provided by the support 174. The upper cog rotates with the belt 170. The lower cog 184 rotates as a result of being connected to the upper cog 182. The lower cog 184 rotates the cutting disc 168. The cutting disc 168 includes gear interface 188 in the form of a number of inwardly facing gear engagers 190.

In this embodiment the cutting disc 168 includes a bicycle chain type gear interface 188 forming part of a securing arrangement 191 of the disc 168. The securing arrangement supports clip on blades for food processing. The securing arrangement 191 includes at least three rigid arms 192 that connect to a food implement holder 194. An internal bearing arrangement connects the food implement holder 194 to the mount 176 and maintains proper alignment. The cutting disc 168 is arranged to rotate as shown in FIG. 18. The mount 176 provides a stable centre bearing while the food implement holder 194 is held in place, rotates and spins. A number of springs 196 adjust to provide a biasing force to the mount 176. Attachments 198 are provided in the mount 176 for this purpose.

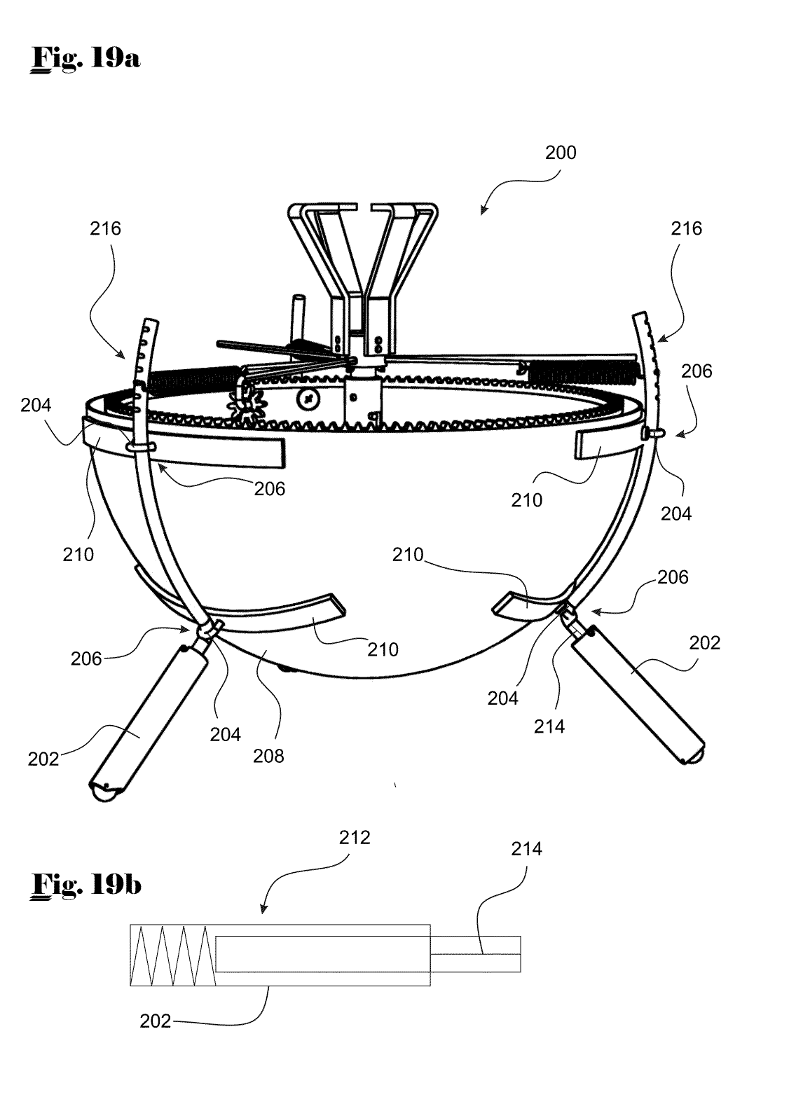

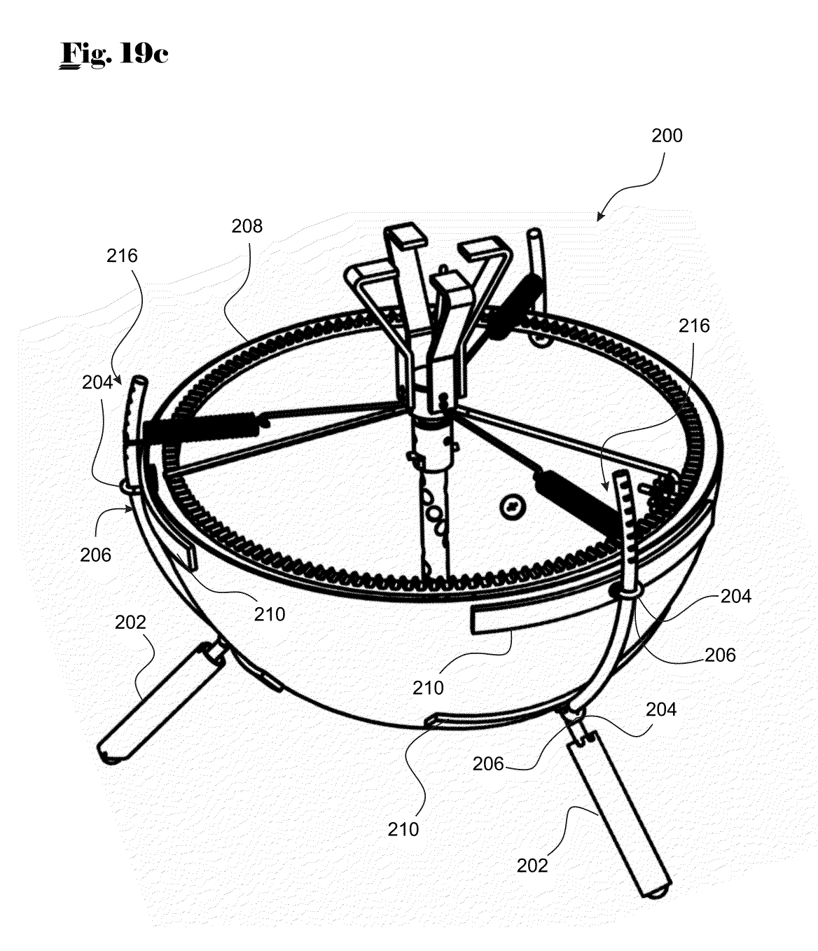

Referring to FIGS. 19a to 19c, there is shown a further embodiment of the present invention in the form of a mixer 200. In the embodiment support legs 202 are threadable through and removable from securing portions 204 in the form of hooks 206 extending from the bowl 208. Various types of eyebolts and other hooks could be used. The securing portions 204 include reinforcement portions 210 for strengthening the bowl 208. Each of the legs includes a weight measuring arrangement 212. The weight measuring arrangement 212 provides a legible scale 214. By having the weight measured by the legs several advantages are provided for the baker. In addition the legs 202 each provide spaced apart attachment portions 216 for the attachment height of the springs. It is envisaged that a heat source or refrigerating device could also be placed beneath the bowl 208. Various forms of gearing arrangements are envisaged including compact inline gearing arrangements.

Thus it will be appreciated that preferred embodiments of the present invention described provide:
(i) Kitchen appliances and methods that can be used for kneading dough, blending fluids, whipping eggs and general mixing in which there is provided a natural tendency for the kitchen appliance to provide a circular action.
(ii) Kitchen appliance and methods allowing for advantageous tipping of the bowl to allow removal of processed food stuffs and for the bowl to receive further foods stuffs for subsequent processing.
(iii) Kitchen appliances and methods in which there are provided an advantageously reduced number of components that can be readily assembled and disassembled and which allow for convenient storage
(iv) Kitchen appliances and methods providing mixers with say 5 to 60 plus litre capacities where the mixers have advantageous stability characteristics without necessarily having to provide a conventional bowl holding stands possibly weighing several kilograms or, in the case of commercial mixers, several tens of kilograms.
(v) Kitchen appliances and methods providing mixers in which the manufacture thereof advantageously is considered to involve much less welding and machining.
(vi) Kitchen appliances and methods providing mixers where motors can be readily maintained and replaced.
(vii) Kitchen appliances and methods in which the full motor and motor housing can be switched for different food processing applications.
(viii) Kitchen appliances and methods where mixers are provided that are considered to be much more effective in terms of their manufacturing cost and overall weight in comparison to their mixing capacity.

As would be apparent, various alterations and equivalent forms may be provided without departing from the spirit and scope of the present invention. This includes modifications within the scope of the appended claims along with all modifications, alternative constructions and equivalents.

There is no intention to limit the present invention to the specific embodiments shown in the drawings. The present invention is to be construed beneficially to the applicant and the invention given its full scope.

In the present specification, the presence of particular features does not preclude the existence of further features. The words ‘comprising’, ‘including’ and ‘having’ are to be construed in an inclusive rather than an exclusive sense.

It is to be recognised that any discussion in the present specification is intended to explain the context of the present invention. It is not to be taken as an admission that the material discussed formed part of the prior art base or relevant general knowledge in any particular country or region.

1-38. (canceled)

39. A mixing device comprising:
a bowl structure for receiving material; and
a connector for allowing a motor to turn a mixing implement within the bowl structure wherein the connector is arranged to allow the mixing implement to move by rotating away from a central axis of the bowl structure.

40. The mixing device as claimed in claim 39, wherein the connecter is arranged to allow the mixing implement to automatically move such that the mixing implement naturally circulates in a desirable manner when being turned in the bowl structure by the motor.

41. The mixing device as claimed in claim 39, wherein the bowl structure has a substantially hemispherical inner mixing surface arranged to allow the mixing implement to be rotated by at least 10 degrees away from the central axis of the bowl structure.

42. The mixing device as claimed in claim 39, wherein the bowl structure has a substantially hemispherical inner mixing surface arranged to allow the mixing implement to be rotated by at least 20 degrees away from the central axis of the bowl structure.

43. The mixing device as claimed in claim 39, wherein the bowl structure has substantially hemispherical inner mixing surface arranged to allow the mixing implement to be rotated by at least 40 degrees away from the central axis of the bowl structure.

44. The mixing device as claimed in claim 39, wherein the connector includes at least two location members for centrally locating the connector relative to the central axis of the bowl structure.

45. The mixing device as claimed in claim 44, wherein each of the location members are adapted to resist rotation and resiliently bias the connector towards an aligned condition in which the mixing implement is aligned with the central axis of the bowl structure

46. A mixing device comprising:
a bowl structure for receiving material; and
a support structure for supporting the bowl structure above a surface, the support structure comprising at least three leg portions, each leg portion having a surface support portion and fastening portion, wherein when the at least three leg portions support the bowl structure, the surface support portions are spaced outside the bounds of the fastening portion such that loading the bowl structure with material causes the fastening portions to be biased inwardly towards the central axis of the bowl structure and the surface support engagement portions to be biased outwardly away from the central axis of the bowl structure.

47. The mixing device as claimed in claim 46,wherein biasing of the surface support portions outwardly away from the central axis of the bowl structure serves to assist with supporting the bowl structure.

48. The mixing device as claimed in claim 46, wherein the mixing device can be tipped in a tipping direction to empty the bowl structure by raising one of the leg potions with the other leg portions supporting the bowl structure above the surface to hold the bowl structure in the tipped condition and to prevent lateral rotation of the bowl structure about the central axis of the bowl structure.

49. A mixing device comprising:
a bowl structure for receiving material; and
a connector, the connector comprising at least two elements for suspending a motor above the bowl structure, the elements being adapted to extend from the periphery of the bowl structure to the motor so as to suspend the motor above the bowl structure in position.

50. The mixing device as claimed in claim 49, wherein the connector is adapted to allow the motor to rotate away from a central axis of the bowl structure such that when a mixing implement is connected to the motor, the mixing implement is able to rotate in a desirable manner and wherein the bowl structure has a substantially hemispherical inner mixing surface arranged to allow the motor and mixing implement to be rotated by at least 5 degrees away from the central axis of the bowl structure.

51. A mixing device method: comprising providing a mixing device by providing a bowl structure having at least a substantially hemispherical base portion, using support members to support the bowl structure and then holding the support members together using a connector for supporting motor above the bowl structure.

52. The method as claimed in claim 51 including suspending the motor above the bowl structure using the connector, and connecting a correspondingly shaped hemispherical shaped mixing implement to the motor such that the device extends downwardly into the bowl structure.

53. The method as claimed in claim 52 including turning the material implement device using the motor as well as rotating the mixing implement away from the central axis of the bowl structure a desirable manner such that the mixing implement travels up and down the inner surface of the bowl structure.

54. The method as claimed in claim 53 including operating the motor with the mixing implement automatically providing a desirable circular action serving to assist with the preparing material within the bowl structure.

55. A kitchen appliance comprising:
a bowl for receiving foodstuffs; and
a connector for allowing a motor to turn a food stuff preparation implement within the bowl wherein the connector is arranged to allow the food stuff preparation implement to move by rotating away from a central axis of the bowl in a desirable manner.

56. A kitchen appliance comprising:
a bowl for receiving foodstuffs; and
a support structure for supporting the bowl above a surface, the support structure comprising at least three leg portions, each leg portion having a surface support portion and fastening portion wherein when the at least three leg portions support the bowl the surface support portions are spaced outside the bounds of the fastening portion such that loading the bowl with food stuff causes the fastening portions to be biased inwardly towards a central axis of the bowl and the surface support engagement portions to be biased outwardly away from the central axis of the bowl.

57. A mixer comprising:
a bowl for receiving material; and
a connector wherein the connector comprises at least two elements for suspending a motor above the bowl, the elements being adapted to extend from a periphery of the bowl to the motor so as to suspend the motor above the bowl in position.

58. The mixer as claimed in claim 57 wherein including a mixing implement adapted to be mounted to the motor; the motor being suspended to allow the mixing implement to be rotated away from a central axis of the bowl structure in a desirable manner.

59. The mixer as claimed in claim 58 wherein the motor is adapted to rotate to allow the mixing implement to be rotated by at least 20 degrees away from the central axis of the bowl structure.
